(19) United States
(12) Patent Application Publication
(10) Pub. No.: US 2007/0208775 A1
(43) Pub. Date: Sep. 6, 2007

(54) Comprehensive Dog Agility Course and Animal Performance Software Application Model

(76) Inventor: David Joseph Proe, Miami, FL (US)

Correspondence Address: DAVID JOSEPH PROE, 2550 SW 21ST STREET, MIAMI, FL, 33145, US

(21) Appl. No.: 11/308,046

(22) Filed: Mar. 3, 2006

(51) Int. Cl. G06F 7/00

(52) U.S. Cl. 707/104.1

(57) ABSTRACT

Participation in dog and animal performance activities can result in a cumbersome and unwieldy accumulation of tracking data as well as physical articles such as paper course design sheets and audio visual clips recorded on magnetic media. These items are related but not connected in any functional way by default and are stored and retrieved via separate and incompatible methods. Existing applications do not address this accumulation nor do they adequately provide a reasonable means of connection and retrieval of the same. A course can be retrieved and printed out for use by a trainer, handler, judge, or other. Performance statistics and notes related to the performance of the course can be retrieved from the searchable database. Audio/visual clips of said performance can be displayed if desired via this application model as well. In short, articles such as audio-visual clips and graphic (courses) are reduced to digital forms and along with statistical data input and archived via the interfaces programmed into the application. They can be easily retrieved and presented as a single data, media grouping.

This application model allows for the programming of 3 layers: The input interface layer allows the user to input 3 types of data items each with one or more interfaces programmed. Graphic course sheet data can be entered into the system via the scanner interface, the existing image file load interface and the external course design load interface. The scanner interface has the ability to scan an image as an image and the ability to scan an image as an editable mapping of course objects and text based information (ICR). The existing image load interface has the ability to load an image as an image file and also to scan the image file in order to produce an editable mapping of course objects and text based information (ICR). Each interface is coded as a separate interface and can be used as is excluding the other graphic image input interfaces. Audio-visual clips can be entered into the system via the Audio-visual interface.

Tracking data can be entered either manually via keyboard or mouse operation into data input forms. Finally, the application model allows for an additional input interface that accepts streaming data as input. This data stream may be provided via electronic means (download) or via a barcode device and may contain either course design data and or dog tracking data.

The data input into the system from the input interfaces is stored either directly (tracking data) or indirectly via pointers in two or more tables in one or more Microsoft Access (mdb) format database. The middle layer of the application model consists of this database and the programming created to extract the data and pass it to the third layer. This programming results in tools to facilitate searching the database for the desired data items and retrieving the items in order to pass them to the third layer, the presentation layer.

The presentation layer consists of output interfaces. The model allows for a report interface that displays and prints extracted tracking data. The model allows for an audio-visual interface that allows for the playback of recorded performances. The model allows for a graphic printing interface that allows for both temporary modification of a retrieved course design (rotation, cropping, grid etc) and the printing of the resulting course. The output interfaces work together to present all of the related data items of any nature at the same time if desired.

What is claimed is:

1. Existing software has the function of tracking performance statistics. Existing software has the ability to modify and print existing course designs. Existing software has the function of referencing scanned course images. This application is unique in that its database is mainly keyed on course images and has incorporated enhanced image processing in order to facility creation and maintenance of this database. Additional special course collections can be added as modules by adding additional tables. These can be created by renowned trainers and distributed as an add-on enhancement.

2. This application is unique in that it allows processing of digital and analog video renditions of course performance and provides database reference and access to the same.

3. This application is unique in that it incorporates database and reporting elements of performance tracking with course graphics image processing, course statistics and video representations of the actual performance of the animals performing the course resulting in the statistics represented in the database attached to the course. The 4 elements are presented as a multi-dimensional unit. This application thus provides a means to reduce or eliminate the necessity of storing course images on paper and provides a means to reduce or eliminate the necessity of storing video performance renditions on magnetic tape. By providing the means to store both of the aforementioned as part of an electronic database, they can be retrieved, viewed and manipulated when referred to or searched via animal, creator, performance or other data entered into the fields of the database.
